(19) United States
(12) Patent Application Publication
(10) Pub. No.: US 2014/0210322 A1
(43) Pub. Date: Jul. 31, 2014

(54) POINT OF PURCHASE SYSTEM HAVING TRANSPARENT DISPLAYS

(71) Applicant: 3M INNOVATIVE PROPERTIES COMPANY, St. Paul, MN (US)

(72) Inventors: Ralph R. Roberts, Cottage Grove, MN (US); Jane K. Wardhana, Jakarta (ID); Patrick A. Thomas, Lake Elmo, MN (US); Rolf W. Biernath, Wyoming, MN (US); Brian T. Weber, Saint Paul, MN (US)

(73) Assignee: 3M INNOVATIVE PROPERTIES COMPANY, ST. PAUL, MN (US)

(21) Appl. No.: 13/749,765

(22) Filed: Jan. 25, 2013

(51) Int. Cl. G03B 21/14; A47F 3/00

(52) U.S. Cl. CPC G03B 21/145; A47F 3/007
USPC 312/10.1; 312/114

(57) ABSTRACT

A transparent display booth for displaying products and providing product-related information. The display booth includes a bottom panel, a back panel, a transparent front plate opposite the back panel, and a transparent display device located co-extensive with the front plate. The bottom and back panels have reflective inner surfaces. The transparent display device can electronically display product-related information, and products located in an interior of the display booth are viewable through the transparent display device to showcase the products and offer them for sale. Multiple transparent display booths can be combined to form a networked retail system.

### BACKGROUND

Transparent liquid crystal display (LCD) devices have been demonstrated as front surfaces for enclosures. In these configurations one face of the enclosure, for example the top surface, is a light box illuminating surface. This light box can be a traditional LCD backlight unit reconfigured to function as such a surface. The other non-display surfaces largely serve to direct light from the illumination surface through the back side of the display surface to the viewer, which is achieved by repeated reflection inside the enclosed area until the light exits the display area.

These displays can be used in a point of purchase (POP) environment. However, in some POP environments, display items are frequently added to or removed from the display enclosure, causing disruption of the illumination received by the front panel of the display enclosure. An example of such a POP environment includes delicatessen counters where there is significant interaction between the customer and retailer in making product selections. Accordingly, a need exists for improved lighted enclosures incorporating transparent displays for retail or other environments.

### SUMMARY

A transparent display booth for displaying products and providing product-related information, consistent with the present invention, includes a bottom panel having a reflective inner surface, a back panel having a reflective inner surface, a transparent front plate opposite the back panel, and a transparent display device located co-extensive with the front plate. The transparent display device can electronically display product-related information, and a product located in an interior of the display booth is viewable through the transparent display device.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of a retail service system with transparent display devices;

FIG. 2 is a side sectional view of a transparent display booth;

FIG. 3 is a front view of the transparent display booth of FIG. 2;

FIG. 4 is a top view of the transparent display booth of FIG. 2; and

FIG. 5 is a front perspective view of the transparent display booth of FIG. 2.

### DETAILED DESCRIPTION

Embodiments of the present invention include display systems having at least one transparent display device housed in an at least partially open booth. The booth is open in that a part of the booth is not completely enclosed but, rather, is open to the environment while maintaining a product viewing experience for customers or others. The display system is advantageous in providing, for example, fast throughput from customer selection to checkout by improved communication between the customer and retailer. The display panels of the system allow correlation of product information with product viewing to enhance the retail or other experience for the customer. The system can be configured to provide information-on-demand pertaining to products that are viewed by customers or others.

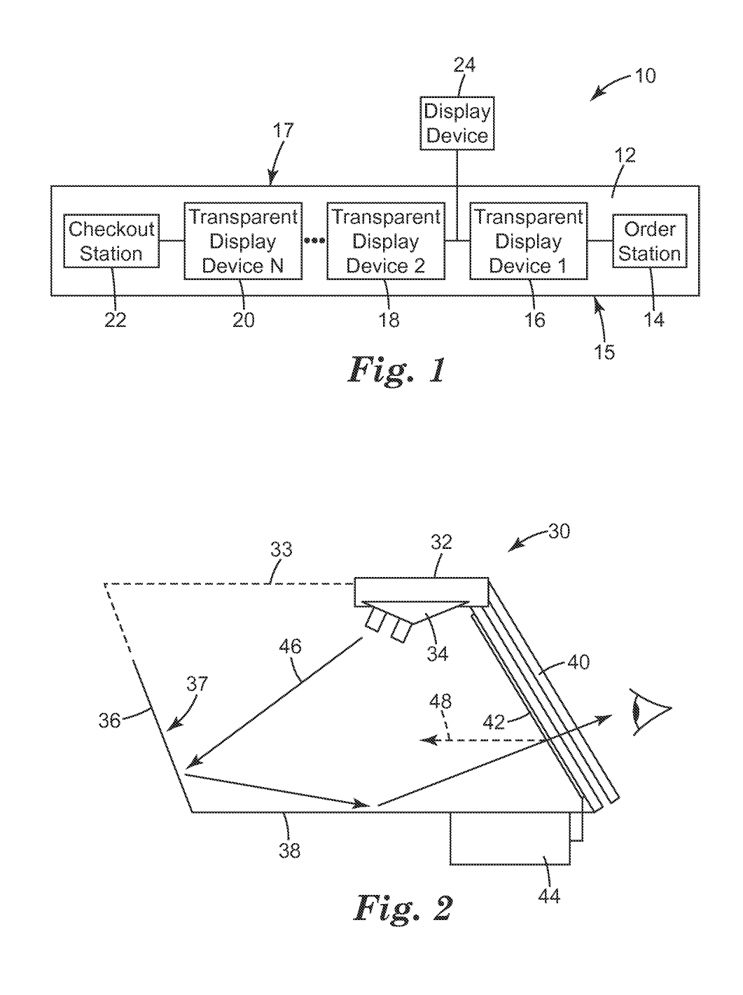

FIG. 1 is a diagram of a retail service system 10 with transparent display devices. System 10 includes a counter 12 having transparent display devices 16, 18, and 20 for displaying information concerning products and for allowing a customer to view products on counter 12 through the transparent display devices. Counter 12 also includes an optional order station 14 for a customer to submit an order and an optional checkout station 22 for the customer to pick up an order. The transparent display devices can be electronically connected with a non-transparent display device 24 for providing product information or other information. Counter 12 includes a customer side 15 for a customer to view products and information concerning them, and a retailer side 17 for a retail establishment to show products and provide for sale of them to customers.

In use, a customer on customer side 15 can see products behind transparent display devices 16, 18, and 20. The customer can make a product selection by use of, for example, a menu visible on one or more of the transparent display devices. Methods for communicating with the transparent display devices can include one or more of the following: use of a touch screen; a proximity or motion sensor; a gesture sensor; or voice recognition. The information concerning the customer's selection can be conveyed to a server on retailer side 17 who is able to provide the selection. As the customer advances through the service line along customer side 15, the displayed product-related or other information can be transferred along the transparent display devices 16, 18, and 20, which can be electronically networked together as shown. Relevant information to be displayed on the transparent display devices as the customer advances includes, for example, a summation of total purchase cost, savings, sale items, and other such information. On reaching the end of the service line at checkout station 22, the information relevant for completing the purchase can be displayed on an integrated cashier's display device. Only three transparent display devices are shown in FIG. 1 for illustrative purposes only; the system can be scaled to include more or fewer display devices.

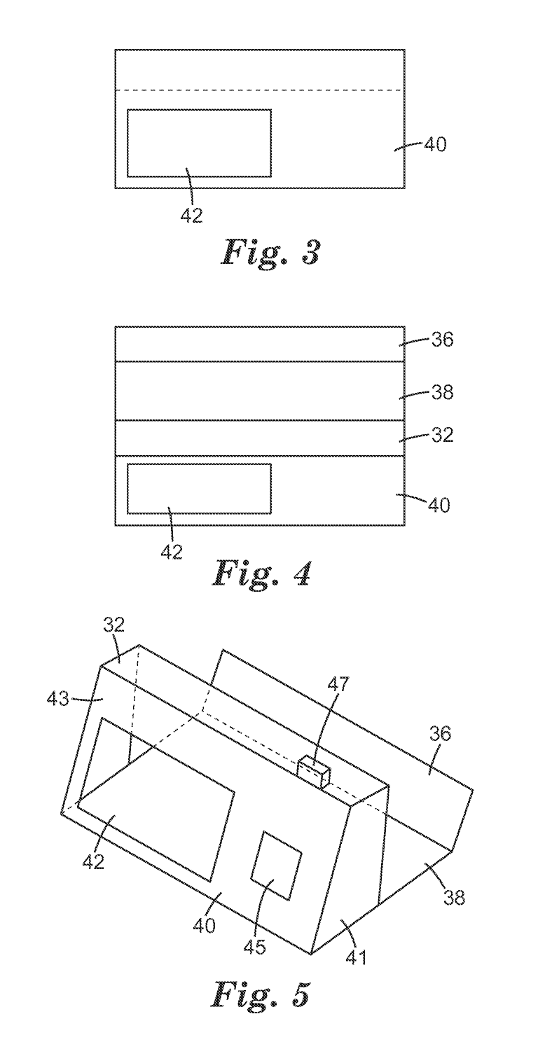

FIG. 2 is a side sectional view of a transparent display booth 30 for displaying products with a transparent display device incorporated into the booth for displaying product-related or other information. FIGS. 3-5 are front, top, and front perspective views, respectively, of transparent display booth 30. This type of transparent display booth can be incorporated into retail system 10 shown in FIG. 1 to house transparent display devices 16, 18, and 20, and display or showcase products or other items.

Booth 30 includes a bottom panel 38 for displaying one or more products, a back panel 36, a top panel 32, a transparent front plate 40, and a transparent display device 42. Back panel 36 has a bottom edge adjacent a back edge of bottom panel 38, and back panel 36 has a reflective inner surface 37. Front plate 40 has a bottom edge adjacent a front edge of bottom panel 38 and is located opposite back panel 36. Top panel 32 has a front edge adjacent a top edge of front plate 40 and is located opposite bottom panel 38. Transparent display device 42 is located co-extensive with the front plate 40. Front plate 40 is shown as a double-paned plate but could be implemented with a single transparent pane. Bottom panel 38, back panel 36, and front plate 40 form an interior of display booth 30, and booth 30 includes an open portion 33 between a back edge of top panel 32 and a top edge of back panel 36 for allowing access to the interior of the booth.

Booth 30 can also include the following components. A lighting unit 34 is mounted to an underside of top panel 32 for lighting the interior of the booth. Drive electronics 44, which can include a processor, are located underneath bottom panel 38 and electronically connected with transparent display device 42 for controlling the device. Booth 30 can also include side panels 41 and 43, as shown in FIG. 5, extending between bottom panel 38 and top panel 32 for proving mechanical support and to further enclose the interior. Side panels 41 and 43 can optionally be transparent to further enhance viewability of products or other items in the interior of the booth. Side panels 41 and 43 can optionally be reflective to direct light onto reflective surfaces 36 and 38. This mode has improved efficiency of light throughput to the backside of transparent display 42. When the interior of booth 30 is illuminated by lighting unit 34, products or other items inside the booth are viewable through transparent display device 42 and front plate 40 as represented by lines 46.

The following are various configurations for booth 30. In one configuration the transparent display device is supported onto an existing transparent front plate of the booth. The transparent display device can be placed either on the viewer side or on the back surface of the front plate when used. When the front plate is used, the transparent display device is co-extensive with the transparent front plate, meaning it covers at least a portion of the front plate. In another configuration the transparent display device is the total front surface of the booth and is implemented as transparent front plate 40, in which case bottom panel 38, back panel 36, and transparent display device 42 form the interior of display booth 30. Depending on the choice of configuration of the front surface of the booth, other functionalities can be incorporated into the front plate or transparent display device such as antimicrobial coatings; scuff or scratch resistant hard coatings; and antireflective; and anti glare coatings. These same coatings can also be applied to the back side of front plate 40 or display device 42. Additionally, the back side of the front plate 40 or display device 42 can be outfitted with a reflective polarizing mirror with the pass axis aligned in such a way as to allow the maximum amount of light to pass through display device 42, while reflecting any light back to the product (represented by line 48 in FIG. 2) that would otherwise be absorbed by the polarizers on the LCD, thereby enhancing the brightness of the product or work space.

Back panel 36 and front plate 40 are shown arranged non-perpendicular with bottom panel 38 and, in particular, angled backward from the front of the booth. Such configuration may allow easier viewing when a customer is looking down into the booth. Back panel 36 and front plate 40 can alternatively be angled forward with respect to the front of the booth or arranged perpendicular with bottom panel 38. Furthermore, back panel 36 can be perpendicular with bottom panel 38 while front plate 40 is angled backward.

Bottom panel 38 can alternatively be implemented using a portion of counter 12. If the counter is used as the bottom panel, the back panel and front plate can optionally be affixed to the counter. By using a separate panel to implement bottom panel 38, booth 30 can have greater ease of portability. Furthermore, an inner surface of the bottom panel (facing the interior of the booth) can be reflective, or have particular graphics, to enhance the showcasing of products or other items located in the interior of the booth.

Lighting unit 34 can be implemented with one or more light sources such as fluorescent, incandescent, or light emitting diode (LED) sources. Lighting unit 34 can be mounted to the top panel, as shown, or mounted elsewhere proximate booth 30. These light sources serve to both illuminate products or other items positioned in the interior of the booth behind the transparent display device as well as to backlight the transparent display device. If a transparent display device not requiring backlighting is used, then the light sources can still be used to illuminate products in the booth. The amount of lighting needed correlates to the light transmission of the transparent display device. A display device of about 7% light transmission requires substantial backlighting while a display device of about 30% light transmission requires minimal backlighting. An example of a commercially available display device is the SAMSUNG transparent LTI220MT02 color LCD module having 12-15% light transmission. One configuration of the illumination source includes a rim lighting unit positioned behind the transparent display device and serving primarily to illuminate objects within the booth. Another configuration includes a spot-lighting arrangement also serving to primarily illuminate objects in the booth. Other configurations can include a combination of rim and spot lighting units. In one mode reflective surface 37 on back panel 36 reflects greater than 90% and preferably about 95% or more of incident light. Reflective surface 37 can be a diffuse or specular reflective surface, or both. Reflective surface 37 can alternatively be curved, allowing for light impinging on its surface to be largely reflected to the back panel of the transparent display device and then to the viewer. Reflective surface 37 can cover the entire inner surface of back panel 36 or a portion of it and can be implemented with a surface treatment of the back panel or with a coating or reflective film on the back panel. One exemplary reflective film material is the 3M Light Enhancement Film 3635-100 with documented 94.5% light reflectance.

As illustrated in FIG. 5 and reference above with respect to retail service system 10, booth 30 can optionally include a touch screen 45 or sensor 47, or both, for use in interacting with a customer or user. Touch screen 45 can be implemented with, for example, a capacitive single touch display electronically connected with booth 30 such as via drive electronics or processor 44. Touch screen 45 can be mounted on the front plate, as shown, or located proximate booth 30. A customer or user may enter information into touch screen 45 such as a request to purchase the displayed product. Sensor 47 can be implemented with a proximity or motion sensor, a gesture sensor, or a microphone for voice recognition, with sensor 47 electronically connected with booth 30 such as via drive electronics or processor 44 for receiving commands from a customer or user. Sensor 47 can be mounted on the top panel, as shown, or located proximate booth 30. An example of a depth sensor for detecting gestures is the KINECT sensor from Microsoft Corporation and the sensor described in U.S. Patent Application Publication No. 2010/0199228. When a gesture sensor is used, booth 30 can detect a user selecting an item displayed on display device 42. When voice recognition is used, booth 30 can detect a verbal command from a user. When a motion sensor is used, booth 30 can display a message on display device 42 when detecting the presence of a user, for example.

The various panels of the transparent display booth have edges, or other portions, adjacent one another as shown. The edges or portions of the panels can be adjacent one another by being in direct contact, by being connected through one or more other components such as a frame, or by being held next to one another.

Reconfiguration of existing display cases that comprise a transparent front surface, rear and bottom panels are within the scope of embodiments of this invention.

The contrast of the transparent display devices in the display booth can be modified or enhanced by conditioning the images displayed upon them. In particular, to enhance the contrast of the displayed image on the transparent display devices the original pixels are remapped so that portions of the display that the user wants to be transparent are mapped to luminance values that correspond to luminance values having been defined as being in the transparent range. For example, in a transparent display device where brighter pixels are perceived as more transparent, pixels that the user wants to be perceived as transparent can be remapped to a pixel luminance value of 255, and pixels that the user wants to be non-transparent can be remapped to luminance values that correspond to luminance values enhancing the visibility of the displayed image. Other pixel remapping schemes can include linear transforms, non-linear transforms, or both. For example, in one scheme luminance values of brighter pixels can be remapped to be perceived as more transparent, and in another scheme luminance values of darker pixels can be remapped to be perceived as more transparent.

1. A transparent display booth for displaying products and providing product-related information, comprising:
a bottom panel having a reflective inner surface;
a back panel adjacent to the bottom panel and having a reflective inner surface;
a transparent front plate adjacent to the bottom panel opposite the back panel; and
a transparent display device located co-extensive with the transparent front plate,
wherein the bottom panel, the back panel, and the transparent front plate form an interior of the transparent display booth,
wherein the transparent display device can electronically display product-related information, and a product located in the interior of the transparent display booth is viewable through the transparent display device.

2. The transparent display booth of claim 1, further comprising a top panel adjacent to the transparent front plate opposite the bottom panel.

3. The transparent display booth of claim 1, further comprising a lighting unit for illuminating the interior of the transparent display booth.

4. The transparent display booth of claim 2, further comprising a first side panel adjacent to and extending between the bottom panel and the top panel and a second side panel, opposite the first side panel, adjacent to and extending between the bottom panel and the top panel.

5. The transparent display booth of claim 2, wherein the top panel and the back panel form an open portion allowing access to the interior of the transparent display booth.

6. The transparent display booth of claim 1, wherein the transparent display device does not completely cover the transparent front plate.

7. The transparent display booth of claim 1, wherein the back panel is non-perpendicular with the bottom panel.

8. The transparent display booth of claim 1, wherein the transparent front plate and the transparent display device are non-perpendicular with the bottom panel.

9. The transparent display booth of claim 1, further comprising a reflective polarizer located adjacent a backside of the transparent display device, wherein the reflective polarizer is aligned with a pass axis of the backside of the transparent display device.

10. The transparent display booth of claim 1, further comprising a touch screen located proximate and electronically connected with the display booth.

11. The transparent display booth of claim 1, further comprising gesture sensor located proximate and electronically connected with the display booth.

12. A retail service system with transparent display devices, comprising:
a counter;
a first transparent display booth located on the counter, the first transparent display booth comprising:
a first bottom panel having a reflective inner surface;
a first back panel adjacent to the first bottom panel and having a reflective inner surface;
a first transparent front plate adjacent to the first bottom panel opposite the first back panel; and
a first transparent display device located co-extensive with the first transparent front plate; and
a second transparent display booth located on the counter adjacent the first transparent display booth, the second transparent display booth comprising:
a second bottom panel having a reflective inner surface;
a second back panel adjacent to the second bottom panel and having a reflective inner surface;
a second transparent front plate adjacent to the second bottom panel opposite the second back panel; and
a second transparent display device located co-extensive with the second transparent front plate,
wherein the first transparent display device is electronically connected with the second transparent display device,
wherein the first bottom panel, the first back panel, and the first transparent front plate form a first interior of the first transparent display booth,
wherein the second bottom panel, the second back panel, and the second transparent front plate form a second interior of the second transparent display booth,
wherein the first and second transparent display devices can electronically display product-related information, and products located in the first and second interiors of the first and second transparent display booths are viewable through the first and second transparent display devices.

13. The retail service system of claim 12, further comprising a non-transparent display device located proximate the first or second transparent display booths and electronically connected with the first and second transparent display devices.

14. A transparent display booth for displaying products and providing product-related information, comprising:
a bottom panel having a reflective inner surface;
a back panel adjacent to the bottom panel and having a reflective inner surface; and
a transparent display device adjacent to the bottom panel opposite the back panel,
wherein the bottom panel, the back panel, and the transparent display device form an interior of the transparent display booth,
wherein the transparent display device can electronically display product-related information, and a product located in the interior of the transparent display booth is viewable through the transparent display device.

15. The transparent display booth of claim 14, further comprising a top panel adjacent to the transparent display device opposite the bottom panel.

16. The transparent display booth of claim 14, further comprising a lighting unit for illuminating the interior of the transparent display booth.

17. The transparent display booth of claim 15, further comprising a first side panel adjacent to and extending between the bottom panel and the top panel and a second side panel, opposite the first side panel, adjacent to and extending between the bottom panel and the top panel.

18. The transparent display booth of claim 15, wherein the top panel and the back panel form an open portion allowing access to the interior of the transparent display booth.

19. The transparent display booth of claim 14, wherein the back panel is non-perpendicular with the bottom panel.

20. The transparent display booth of claim 14, wherein the transparent display device is non-perpendicular with the bottom panel.

21. The transparent display booth of claim 14, further comprising a reflective polarizer located adjacent a backside of the transparent display device, wherein the reflective polarizer is aligned with a pass axis of the backside of the transparent display device.

22. The transparent display booth of claim 14, further comprising a touch screen located proximate and electronically connected with the display booth.

23. The transparent display booth of claim 14, further comprising gesture sensor located proximate and electronically connected with the display booth.
